(19) United States
(12) Patent Application Publication
(10) Pub. No.: US 2014/0167423 A1
(43) Pub. Date: Jun. 19, 2014

(54) GENERATOR CONTROL SYSTEM FOR SMOOTH OPERATION WITH COMBUSION ENGINE

(71) Applicants: Martin Pischinger, Munchen (DE); Jakob Andert, Aachen (DE)

(72) Inventors: Martin Pischinger, Munchen (DE); Jakob Andert, Aachen (DE)

(73) Assignee: FEV GmbH, Aachen (DE)

(21) Appl. No.: 14/109,280

(22) Filed: Dec. 17, 2013

(30) Foreign Application Priority Data
Dec. 17, 2012 (DE) DE102012024551.3

(51) Int. Cl. H02P 9/04

(52) U.S. Cl. CPC H02P 9/04
USPC 290/40 A

(57) ABSTRACT

A combustion engine comprising at least a cylinder, a generator having a generator shaft with a generator shaft gear, a crankshaft having a crankshaft gear and a control unit, which controls at least the generator in such a way that it is possible to avoid a tooth flank change between the generator shaft gear and the crankshaft gear during an entire combustion cycle of the combustion engine.

### CROSS-REFERENCE TO RELATED APPLICATIONS

The disclosure of German Patent Application DE 10 2012 024 551.3 filed on Dec. 17, 2012, including the specification, drawings, and abstract, is incorporated herein by reference in its entirety.

### FIELD OF THE INVENTION

The invention relates to a combustion engine comprising at least one cylinder, a generator having a generator shaft with a generator shaft gear, a control unit which controls at least the generator, and a rotational connection which connects a crankshaft having a crankshaft gear of the combustion engine with the generator shaft. In the process, the generator shaft rotates in the opposite direction of the crankshaft and is arranged in parallel fashion to the crankshaft. The products of moments of inertia and the respectively associated speed ratios of individual rotary components rotationally coupled by means of the rotational connection cancel each other out at least approximately.

### BACKGROUND OF THE INVENTION

Combustion engines with a generator are a well-known element of prior art. Also known are generators which are connected with the crankshaft of a combustion engine by means of a timing belt. In addition, there are generators which are connected with the crankshaft of a combustion engine by means of a gear connection. The EP 0 847 490 B1 describes an electric machine which is arranged at the crankshaft of the combustion engine. Said electric machine is controlled in such a way that it counteracts torque fluctuations which are caused by load changes, or externally by torque thrusts introduced in the power transmission via a drive wheel. It is also a well-known fact that an electric machine which is arranged at the crankshaft of a combustion engine counteracts the torque fluctuations of the combustion engine by introducing in the crankshaft a torsional reaction toward the torque fluctuation of the combustion engine. At the same time, the electromagnetic machine carries out vibration compensation.

When arranging the generator on an additional shaft, which is connected with the crankshaft by means of a rotational connection, noise emissions occur in addition to the torque fluctuations caused by the combustion engine. These noise emissions occur especially when the combustion engine has a low number of cylinders. When the generator is designed to also generate electric power for an electric drive of a motor vehicle, the noise emissions could disturb a smooth operation of the motor vehicle.

Therefore, it is the objective of the invention to provide a combustion engine with a generator which at least reduces the noise emissions between generator and combustion engine.

### SUMMARY OF THE INVENTION

This objective is achieved with a combustion engine which comprises at least one cylinder, a generator having a generator shaft with a generator shaft gear, a control unit which controls at least the generator, and a rotational connection which connects a crankshaft having a crankshaft gear of the combustion engine with the generator shaft. The generator shaft rotates in the opposite direction of the crankshaft and is arranged in parallel fashion to the crankshaft. The products of moments of inertia and the respectively associated speed ratios of individual rotary components rotationally coupled by the rotational connection almost cancel each other out. The control unit controls the generator in such a way that at least between a first moment prior to the start of combustion in a cylinder and a second moment following the start of combustion in the cylinder a gear force of the generator shaft gear acts on the crankshaft gear, thus decelerating the crankshaft gear.

For example, the start of combustion depending on the crankshaft is provided in the control unit, especially for each individual cylinder of the combustion engine. In particular, the start of combustion in a cylinder results in an increase of pressure in the cylinder, as well as a torque increase at the generator shaft. In one embodiment, the start of combustion can be detected by the control unit. For example, the control unit can receive a signal from the generator, which signal depends on an increase of torque at the generator shaft. The start of combustion can, for example, also be detected by a pressure sensor in the cylinder and/or by a knock sensor.

The first moment prior to the start of combustion, as well as the second moment following the start of combustion can be assigned also in correlation with the crankshaft speed and the crankshaft rotating direction to a position of the crankshaft in crank angle degrees. For example, in one embodiment it is provided that the first moment has been assigned a position of the crankshaft in which the crankshaft is one crank angle degree prior to the position before combustion starts in the respective cylinder. Furthermore, the second moment can be assigned a position of the crankshaft in which the crankshaft is in a position of one crank angle degree behind the position in which combustion starts in the respective cylinder.

For a better understanding of the invention the following definitions apply to the different moments: a gear force multiplied with a space between the teeth of the generator shaft gear and the generator shaft generates a torsional gear force at the generator shaft which is subsequently referred to as a gear force generator shaft torque. Opposite the gear force generator shaft torque, a generator shaft torque acts from the generator shaft to the generator shaft gear.

Preferably, the control unit controls the generator in such a way that an orientation of the generator shaft torque is constant at least in the compression phase of a respective cylinder. In particular, the control unit controls the generator in such a way that, because of the gear force, the crankshaft gear is in permanent contact with the generator shaft gear at least in the compression phase.

Because of the permanent contact, it is possible to avoid a tooth flank change at least during the compression phase of the respective cylinders of the combustion engine. Especially when using the rotational connection through gear wheels, it is possible to reduce noise emissions by avoiding tooth flank changes. Particularly with the use of hybrid drives in which the electric machine is used as generator, as well as electric motor the permanent contact makes it possible to avoid noise emissions even with large components at least during the compression phase. Preferably, it is possible to establish permanent contact between the tooth flanks and meshing gear wheels of the rotational connection when changing from generator to electric motor operation.

Preferably, the combustion engine comprises one cylinder. However, in a further embodiment, the combustion engine can have even two, three, four, five, six, eight or twelve cylinders. Preferably, the generator of the combustion engine is dimensioned in such a way that it supplies power of at least 10 kW into an electrical system. Preferably, said electrical system is connected with an electric motor by which it is possible to move a motor vehicle. In one further development of the invention, said motor vehicle can be moved also with the combustion engine. In a different embodiment, the generator is dimensioned in such a way that it supplies power of between 1 and 10 kW or between 10 and 20 kW into the electric system. In yet another embodiment the power supply into the electric system ranges between 20 and 30 kW. In a different embodiment it ranges between 30 and 40 kW, and in a modified embodiment the power supply ranges between 50 and 100 kW.

Preferably, the combustion engine is operated with variable speed. At the same time, the speed of the combustion engine can depend on a load requirement in relation to the motor vehicle. For example, in an acceleration movement of the motor vehicle, the combustion engine can be operated in a speed range of approximately between 3000 rpm and 6000 rpm. In a further embodiment, when the motor vehicle is stationary, the combustion engine can be operated between approximately 200 rpm and 800 rpm. When the motor vehicle is stationary, the combustion engine can especially be used for heating the motor vehicle, supplying the motor vehicle with power via the generator and/or for recharging a battery via the generator. In particular, the combustion engine can also be used as an emergency power unit. When operating the motor vehicle with a constant speed or approximately constant load requirement, the combustion engine is preferably operated with a constant speed, for example, at 2000 rpm, 2300 rpm or 2600 rpm. In a further embodiment with an approximately constant load requirement, the combustion engine is operated in a speed range of between 2000 rpm and 2500 rpm.

It is especially preferred when the combustion engine comprises two cylinders. In a special embodiment, the combustion engine comprises a rotary engine.

The generator has a generator shaft used to drive the generator. On the generator shaft, a generator shaft gear is located which has been shrunk onto the generator shaft. The generator can be designed as a direct current machine, an asynchronous machine or a synchronous machine. In particular, the generator can be designed as a permanently excited synchronous machine or a synchronous machine with separate excitation. In further embodiments, the generator can be designed as a non-salient pole synchronous machine, a salient pole synchronous machine, a permanently excited direct current machine, a direct current machine with separate excitation or a series direct current machine. The generator is connected with a control unit which controls at least the generator. It is especially preferred when the control unit is also connected with the combustion engine. It is also possible to integrate the control unit in a control device of the combustion engine. It is especially preferred when the control unit controls the amount of the phase current within the generator and/or the armature flux within the generator. In particular, the combustion engine comprises power electronics for controlling the generator. The power electronics especially comprise power inverters for controlling the coils in the generator. In particular, the power electronics can be controlled by pulse-width modulated signals which are transmitted from the control unit to the generator. By the power electronics, it is especially possible to provide high-resolution control of the generator, wherein, for example, the torque can be controlled up to exactly one degree crank angle, which torque is generated by converting the rotational energy of the generator shaft into electric energy.

Furthermore, the combustion engine comprises a rotational connection which couples a crankshaft of the combustion engine with the generator shaft. In particular, the rotational connection can be implemented by an interaction between a generator shaft gear and a crankshaft gear. In the process, the generator shaft gear contacts the crankshaft gear, at least when the combustion engine drives the generator. However, a rotational connection can also involve an interaction between a generator shaft with a generator shaft gear and a crankshaft and crankshaft gear. The rotational connection can also be provided with a contact surface between the crankshaft gear and the generator shaft gear.

The generator shaft is rotating in opposite direction to the crankshaft. In particular, the generator shaft is connected with the crankshaft by means of a single gear connection. The products of moments of inertia and the respectively associated speed ratios of individual rotary components rotationally coupled by means of the rotational connection cancel each other out at least approximately. A description of this process is also included in the DE 10 2010 025 002 A1. In the context of the disclosure of the present invention, reference concerning this matter is made to said patent application.

The control unit controls the generator in such a way that a generator shaft torque is generated which has the result that the generator shaft acts on the generator shaft gear. According to one embodiment, the crankshaft has only one rotational direction and the generator shaft has also only one rotational direction. It is also possible that there is a main rotational direction and an opposite rotational direction.

Subsequently an embodiment is described in detail in an exemplary manner, wherein a transmission ratio between the crankshaft gear and the generator shaft gear of one is assumed. In this connection, the crankshaft torque accelerates the generator shaft by the crankshaft gear and the generator shaft gear, especially during the expansion phase of each cylinder. The control unit controls the generator in such a way that the accelerated crankshaft torque is compensated by a braking torque which is caused among other things by the generation of electric current within the generator over the entire combustion cycle. In particular, with a constant load requirement in relation to the motor vehicle, the control unit controls the generator in such a way that beginning with the first combustion stroke of the combustion engine the generator speed, as well as the speed of the combustion engine are approximately equal to the corresponding generator speed and the speed of the combustion engine at the end of the fourth combustion stroke. During the combustion cycle the speed of the combustion engine is not constant. During the combustion cycle the combustion engine has rotational irregularities. In a further development of the invention, the control unit controls the generator in such a way that during the entire combustion cycle of the combustion engine the generator shaft torque is greater than zero and the orientation of the generator shaft torque remains rectified.

In one further development of the invention, the combustion engine is designed in such a way that during the entire operation cycle of the respective cylinder a gear force originating from the generator shaft gear acts on the crankshaft gear which results in a deceleration of the crankshaft gear. The gear force generates a generator shaft torque which starting from the generator shaft acts via the generator shaft gear and the crankshaft gear on the crankshaft and results in a deceleration during the entire operation cycle of a cylinder of the combustion engine. Preferably, the combustion engine has a combustion cycle of four strokes. Subsequently, the first stroke is depicted as induction stroke, the second stroke as compression stroke, the third stroke as expansion stroke and the fourth stroke as exhaust stroke. In a special embodiment, the combustion engine can be operated even in a two-stroke process. In particular, the permanent contact between the crankshaft gear and the generator shaft gear is maintained during the entire stroke process of the combustion cycle. It is also preferred that the control unit controls the generator in such a way that the generator shaft decelerates the crankshaft in each combustion stroke. For this purpose, an orientation of the generator shaft torque is intended which is maintained during an entire combustion cycle of the combustion engine.

Subsequently, the control system of the control unit which controls the generator is depicted as generator control system. Said generator control system has the effect that during the compression phase or during an entire operation cycle of each cylinder of the combustion engine the crankshaft gear remains in constant contact with the generator shaft gear. The crankshaft gear comprises crankshaft gear sprockets with front gear tooth flanks oriented in rotational direction of the crankshaft. In the same manner, the generator shaft gear comprises generator shaft gear sprockets with a rear gear tooth flank oriented opposite to the rotational direction of the generator shaft. The generator control system is designed in such a way that during the compression phase or during an entire operation cycle of each cylinder of the combustion engine the crankshaft gear has only permanent contact with the generator shaft gear by one or several front gear tooth flanks of the crankshaft gear and by one or several rear gear tooth flanks of the generator shaft gear. This permanent contact between the crankshaft gear and the generator shaft gear has the effect that no contact alterations or tooth flank changes occurs between the crankshaft gear and the generator shaft gear during the compression phase or during the entire operation cycle of each cylinder of the combustion engine.

The generator control system is acting in such a way that, despite the torque fluctuations within a combustion cycle of the combustion engine in which the orientation of the crankshaft torque can change the sign, the generator shaft torque permanently decelerates by the generator shaft gear the crankshaft gear during the compression phase or during the entire operation cycle of each cylinder of the combustion engine. At the same time, the decoration can take place in such a way that the crankshaft gear is decelerated, but not the generator shaft gear. Provision can also be made that during the deceleration process the crankshaft gear and the generator shaft gear are decelerated.

For example, the generator control system takes into consideration that because of the inertia of the crankshaft gear the gear force crankshaft torque differs from the crankshaft torque. Furthermore, according to a further development of the invention, the generator control system can consider that because of the inertia of the generator shaft gear the gear force generator shaft torque differs from the generator shaft torque. In a further embodiment, it is possible that the crankshaft gear and/or the generator shaft gear can act as flywheel masses in order to generate permanent deceleration of the crankshaft gear by means of the generator shaft gear at least during a portion of the compression phase or during the entire operation cycle of each cylinder. This process can also be controlled by the generator control system.

In particular, the generator control system is designed in such a way that the course of the amount of gear force during a compression phase in one of the cylinders of the combustion engine has a local maximum. During a compression stroke, the crankshaft of the combustion engine is decelerated because of the compression pressure in a cylinder. As a result, the speed of the crankshaft is reduced within the compression stroke. However, the generator control system controls the generator in such a way that during the compression stroke the crankshaft is also decelerated by the generator shaft. Preferably, the generator shaft receives a maximum amount of deceleration from the generator control system within the compression stroke of each cylinder. Preferably, the course of the amount of gear force is controlled by pulse-width modulated signals of the control system. For example, the course of the amount of gear force can comprise a square function. In one embodiment, the gear force prior to compression amounts to approximately zero and quickly increases to the maximum value at the start of the compression phase of each cylinder. It can also be provided that shortly after the compression phase the amount of gear force quickly decreases from the maximum value to a value amounting to approximately zero. It is also possible that the gear force decreases to a value between the maximum value and zero. At the same time, it is possible to display the course of the amount of gear force within the operation cycle by squares, provided the combustion engine has only one cylinder. Preferably, the curse of the amount of gear force is displayed with a number of squares which also correspond to the number of cylinders of the combustion engine.

In a further embodiment, the combustion engine is designed in such a way that during an entire combustion cycle of the combustion engine the generator performs a conversion of mechanical energy into electric power. In particular, the generator is accelerated during the expansion stroke of the combustion engine. In the process, a crankshaft torque is acting on the generator shaft. On the one hand, said crankshaft torque accelerates the generator shaft and, on the other hand, counteracts a conversion torque which is generated by the generator by a conversion of mechanical energy into electric power. Preferably, in addition to the compression stroke, the generator shaft is decelerated also by the conversion torque during the induction stroke, the compression stroke and the exhaust stroke of the combustion engine.

A further embodiment provides that the generator control system actively controls or regulates a deceleration process for one, two or three strokes while it does not actively control or regulate a deceleration process for one, two or three strokes of the operation cycle. For example, it is possible to utilize moments of inertia which allow the generator to cause a deceleration in a stroke and which take the generator control system into consideration. In particular, the generator control system is able to deactivate the generator during the expansion phase of each cylinder.

Furthermore, it is possible that a permanent contact of meshing gears is provided only in a specific speed range. For example, provision can be made that in stationary or virtually stationary operation the permanent contact is complete during an operation cycle or at least during the compression phase of each cylinder. However, until reaching said operation, for example, when accelerating or decelerating, there is only incomplete contact.

In a further embodiment, the combustion engine is designed in such a way that is comprises two cylinders. In this embodiment, preferably the amount of the generator shaft torque has a first local maximum during the compression stroke of the first cylinder and a second maximum during the compression stroke of the second cylinder.

In a yet another embodiment, the crankshaft gear comprises a number of teeth which correspond to the number of teeth of the generator shaft gear. This results in the fact that the speed of the crankshaft during the operation of the combustion engine corresponds to the speed of the generator shaft. A different embodiment provides for a transmission ratio between the crankshaft gear and the generator gear with a value of between 0.7 and 1.5. A special embodiment provides that the number of teeth of the generator shaft gear deviates by one, two or three teeth from the number of teeth of the crankshaft gear. Such a minor deviation results in a transmission ratio of almost one and in the fact that during two revolutions of the crankshaft the same teeth of crankshaft gear and generator shaft gear do not come in contact repeatedly.

A further development of the invention provides a combustion engine in which prior to the combustion of the respective cylinder a gear force of the generator shaft gear acts on the crankshaft gear. In this embodiment, it is especially avoided that in addition to the stroke generated by the start of combustion in each cylinder another stroke is generated which is caused by a tooth flank change between the crankshaft gear and the generator shaft gear. In particular, a permanent contact between the generator shaft gear and the crankshaft gear is produced by the gear force, while the crankshaft is positioned between a first crankshaft position of at least one degree crank angle prior to the start of combustion and a second crankshaft position of at least one degree crank angle following the start of combustion. In a special embodiment, the combustion engine is operated in such a way that in a first step, by a measurement of the voltage and/or the power generated by the generator, it is detected in which position of the crankshaft combustion starts within each cylinder or when a tooth flank change takes place within the compression phase of each cylinder. Subsequently, said position is depicted as theoretic tooth flank change position of the crankshaft. In a second step, after detecting the theoretic tooth flank change position of the crankshaft, the generator is controlled in such a way that at least one degree crank angle prior to said position the actual tooth flank change takes place.

According to a further embodiment, the combustion engine comprises a crankshaft position sensor. For example, a model for detecting the crankshaft position has been implemented in the control unit. Preferably, the gear force is controlled and/or regulated depending on the crankshaft position. At the same time, the crankshaft position sensor can be designed as a magnetic sensor, a light beam sensor or as a mechanic sensor. In a further development of the invention, a top and/or bottom dead center of a piston of the combustion engine is detected in the control unit and immediately a respective crankshaft position signal is transmitted to the control unit. Preferably, the top dead center of the cylinder which is positioned closest to the control mode of the combustion engine is detected by the crankshaft position sensor.

In a further embodiment, a model is used for measuring the acceleration of the generator shaft. The maximum acceleration of the generator shaft occurs at the respective pressure maxima of the individual cylinders of the combustion engine. Preferably, a portion of the crankshaft position sensor is attached to the crankshaft. The crankshaft position sensor can involve also an identification mark in the form of coloring at a specific place of the crankshaft.

Also proposed is a method for operating a generator which is coupled by a rotational connection with a combustion engine that has at least one cylinder. Furthermore, the generator comprises a generator shaft wherein the generator shaft is rotating in opposite direction to a crankshaft of the combustion engine and is arranged in parallel fashion to the crankshaft. The products of moments of inertia and the respectively associated speed ratios of individual rotary components rotationally coupled by means of the rotational connection cancel each other out at least approximately. The method provides that of a control unit the generator is controlled in such a way that a gear force originating from the generator shaft gear acts on the crankshaft gear between the moment prior to the start of combustion in a cylinder and the moment following the start of combustion, resulting in the deceleration of the crankshaft gear.

Preferably, the method is used in the combustion engine described above. In particular, the method provides that the generator is accelerated during the expansion stroke of the combustion engine. In the expansion stroke, because of the acceleration of the generator shaft, an opposite decelerating generator shaft torque originating from the generator shaft acts via the generator shaft gear and the crankshaft gear on the crankshaft. During the other strokes, the induction stroke, the compression stroke and/or the exhaust stroke, the accelerated mass of the generator shaft and all rotating components connected with the generator shaft is preferably decelerated by a conversion torque. The conversion torque is produced by the generator by converting rotational energy of the generator shaft into electric power. On the one hand, said conversion torque decelerates the rotating masses of the generator shaft and, on the other hand, the rotating components of the generator which are connected in rotational fashion with the generator shaft, thus decelerating also the crankshaft. In this method, the conversion torque acts in such a way that it decelerates the generator shaft, as well as the crankshaft during the induction stroke, the compression stroke and/or the exhaust stroke.

During the expansion stroke, the crankshaft is preferably decelerated by the mass inertia of the generator shaft. During the expansion stroke, the conversion torque is many times smaller, preferably ten times, in a special embodiment twenty times, but can also amount to zero. In this method, a conversion torque is lower during the expansion stroke than during the compression stroke.

Subsequently, the angular speed of the generator shaft is positively defined with the rotational direction of the generator shaft during the operation of the combustion engine.

For example, the difference from the sum of the frictional torques caused by the moveable components of the generator and acting on the generator shaft and the conversion torque and the sum resulting from the moments of inertia of the generator shaft and the angular acceleration of the generator shaft result in the generator shaft torque. In a special embodiment, the generator shaft torque is always greater than zero, preferably during the induction stroke, the compressions stroke, the expansion stroke and the exhaust stroke. In yet another special embodiment, the control unit controls the generator in such a way that a conversion torques is produced also during the expansion stroke.

In a further embodiment, a method is provided in which a decelerating gear force originating from the generator shaft gear acts on the crankshaft gear over the entire operation cycle of each respective cylinder. Over the entire combustion cycle of the combustion engine, the decelerating gear force generates a permanent contact pressure between tooth flanks of a generator shaft gear of the generator shaft and tooth flanks of the crankshaft gear of the crankshaft. Furthermore, with this method, it is possible to achieve a permanent pretension of the tooth flanks of the generator shaft gear and the crankshaft gear during the operation of the combustion engine. In particular, it is achieved by this method that a direct contact between the crankshaft gear and the generator shaft gear can be implemented only by means of one or several front gear tooth flanks of the crankshaft gear and one or several rear gear tooth flanks of the generator shaft gear.

The front gear tooth flanks are tooth flanks of the crankshaft gear sprockets which are oriented in rotational direction of the crankshaft. Each surface of the front tooth flanks comprises a front gear edge normal. By orthogonal vector decomposition the front gear tooth flank normals can be divided into two perpendicularly stacked vectors. It is at least possible to have one orthogonal vector decomposition of the front gear tooth flank normals in which one vector points in the rotational direction of the crankshaft.

On this basis, the generator shaft gear comprises generator shaft sprockets which have a rear gear tooth flanks each of which has a rear gear tooth flank normal. By orthogonal vector decomposition, these rear gear tooth flank normals can be divided into two perpendicularly stacked vectors. It is at least possible to have one orthogonal vector decomposition of the rear gear tooth flank normals in which one vector points in the opposite direction of the rotational direction of the generator shaft.

In a further embodiment, it is provided that at least between a first moment prior to the start of combustion in a cylinder and a second moment following the start of combustion in the cylinder a direct contact between the crankshaft gear and the generator shaft gear can be implemented only by one or several front gear tooth flanks of the crankshaft gear and one or several rear gear tooth flanks of the generator shaft gear.

In a further embodiment, a method is provided in which the speed of the combustion engine is maintained in approximately constant fashion. At the same time, the term approximately constant should be understood in the way that the speed at the start of the first combustion stroke is almost equal to the speed at the end of the fourth combustion stroke. However, in approximately constant speed, the speed within the combustion strokes of the combustion engine varies slightly. For example, in the compression stroke, the speed of the combustion engine is reduced and during the expansion stroke the speed of the combustion engine is increased. From a first combustion cycle of the combustion engine to a second subsequent combustion cycle of the combustion engine the speed at the start of the first combustion cycle is almost equal to the speed at the start of the second combustion cycle.

Furthermore, provision has been made for a method in which the control unit controls the course of the gear force in such a way that the course of the gear force in a compression phase of each cylinder of the combustion engine amounts to a local maximum. In particular, the control unit controls a conversion torque which decelerates the generator shaft. This conversion torque is strongest especially during the compression phase of each cylinder of the combustion engine.

In a further development of the invention, the control unit controls the generator shaft torque which results from the difference between the conversion torque and the sum of the product of the inertia moment of the generator shaft and the angular acceleration of the generator shaft and the torques caused by the friction. In particular, during a compression stroke of a first cylinder of the combustion engine, said generator shaft torque has a local maximum. In a further development of the invention, during a compression stroke of a first cylinder of the combustion engine, said generator shaft torque has several maxima.

In a further development of the invention, a method has been provided in which a course of the gear force is controlled by the control unit in such a way that during a compression stroke of a second cylinder of the combustion engine the generator shaft torque has a local maximum. The course of the generator shaft torque results from functional connection of the generator shaft torque depending on the crank angle of the crankshaft. In particular, provision has been made for a periodic course of the generator shaft torque which has a periodicity of 720 degrees crankshaft angle. This means that after two revolutions of the crankshaft or after each combustion cycle of the combustion engine the course of the generator shaft torque is repeated. In a single cylinder of the combustion engine, the course of the generator shaft torque comprises a single local or global extreme. When the combustion engine has two cylinders, two local maxima of the course of the generator shaft torque are provided. In particular, the local maxima occur during the compression strokes of the respective cylinders. Preferably, in a two-stroke combustion engine, a gear force originating from the generator shaft gear and acting on the crankshaft gear, and/or the generator torque has a periodicity of 360 degrees crankshaft angle. When the combustion engine is designed as a rotary engine, a gear force originating from the generator shaft gear and acting on the crankshaft gear, and/or the generator shaft torque preferably has a periodicity of 360 degrees crankshaft angle. If the rotary engine has three chambers, the amount of a course of the generator shaft torque preferably has three local maxima.

A further development of the invention proposes a method in which a position of the crankshaft is determined. In particular, a position of the crankshaft is determined in a transmission ratio between crankshaft and generator shaft not equal to one. The crankshaft position is especially determined by a control unit. Preferably, the control unit is also connected with an engine control unit. By said engine control unit the position of the crankshaft can be conveyed to the control unit.

In a further development of the invention, provision has been made for a method in which the position of the crankshaft is determined by a crankshaft sensor and the control unit. In one embodiment, the crankshaft sensor generates a sensor signal when an identification mark arranged at the crankshaft passes the crankshaft sensor. Said sensor signal can be triggered by an optical effect, for example, a light beam. Furthermore, the sensor signal can be triggered also by a magnetic effect, for example, a magnet. Said sensor signal is transmitted from the crankshaft sensor to the control unit. Preferably at the moment when the control unit receives the sensor signal, it assigns the crankshaft a specific position at this moment. At the moment of receiving the sensor signal, the control unit assigns the crankshaft a position which corresponds to the position of a bottom dead center of a first cylinder of the combustion engine. In a further embodiment, a reset function is triggered when the sensor signal is received. Said reset function ensures that the course of the generator shaft torque is adjusted to the prevalent combustion stroke of the combustion engine, and that especially the course of the generator shaft torque during the compression stroke of the combustion engine of a cylinder has a local maximum. In a further embodiment, during the crank angle ranges in which a compression takes place in a cylinder of the combustion engine, the control unit can control the generator in such a way that a constant conversion torque is generated in these crank angel ranges.

A further development of the invention proposes a method in which the position of the crankshaft is determined depending on an acceleration of the generator shaft. The acceleration of the generator shaft can be determined by a signal of a speed sensor, the first derivative and/or the second derivative of said signal. On the other hand, the acceleration of the generator shaft can be detected by means of the current flow generated by the generator, which current flow changes depending on the speed of the generator shaft. For example, by determining the acceleration of the generator shaft by means of the control device, it is possible to determine the bottom and/or the top dead center of the crankshaft at a specific moment.

Furthermore, provision has been made for a method in which the position of the crankshaft is determined depending on a maximum acceleration of the generator shaft. At the same time, a model is used which determines the crankshaft position depending on the maximum acceleration of the generator shaft. The maximum of acceleration occurs during the maximum torque of the combustion engine. The crank angle of the maximum torque of the combustion engine always ranges in specific scope between the top dead center of combustion and the bottom dead center. When the control device detects a maximum torque, it is able to assign a crank angle range to the position of the crankshaft which corresponds to the crank angle range of the expansion stroke of the combustion engine. It is especially preferred that in this model the speed of the generator is also recorded. This can be performed by means of a speed sensor. Via a fixed transmission ratio between the crankshaft and the generator shaft, it is also possible to determine the speed of the generator by means of a speed sensor. By determining the maximum acceleration of the generator shaft at a specific moment and determining the speed of the generator shaft at the same moment, the control device can initiate a change of the generator shaft torque. In a preferred embodiment, with a specific fixed delay time depending on the speed of the generator, the generator shaft torque is increased in a jump function. In a further embodiment, the generator shaft torque is increased in such a way that the course of the generator shaft torque can be constantly differentiated over the entire crank angle range during a combustion cycle of the combustion engine.

In yet another embodiment, provision has been made for a method in which a speed fluctuation of the crankshaft of the combustion engine during a combustion cycle of the combustion engine is at least partially increased by controlling the gear force. In particular, when controlling a generator shaft torque in which the generator shaft torque is maximized during the compression stroke of the combustion engine, the speed fluctuation of the combustion engine can be increased, especially at the crankshaft of the combustion engine. The manner in which the course of the generator shaft torque is controlled can depend particularly also on a load requirement in relation to the motor vehicle and/or on the speed of the combustion engine. Preferably, provision has been made for a method in which the course of the generator shaft torque within a combustion cycle of the combustion engine is controlled depending on the speed of the combustion engine. The method described above in which the speed fluctuations of the crankshaft are increased is contrary to the method described in the EP 0 847 490 B1. Said pamphlet describes an electric which is arranged at the crankshaft of the combustion engine. Said electric machine is controlled in such a way that it counteracts torque fluctuations.

In a preferred embodiment, the combustion engine comprises mass balance. Mass balance can be especially realized when the products of moments of inertia and the respectively associated speed ratios of individual rotary components rotationally coupled by means of the rotational connection cancel each other out at least approximately. By such a mass balance, the speed fluctuations of the combustion engine are not conducted outside of an area which comprises the combustion engine and the generator. Preferably, said area comprises a housing which houses the combustion engine and the generator.

In a further embodiment, provision has been made to use a proposed combustion engine as range extender in a motor vehicle. When using said combustion engine as range extender, the crankshaft comprises preferably a single mechanical rotational connection to a component outside of the combustion engine. This single connection connects the generator shaft with the crankshaft. In this embodiment, the combustion engine is designed to have two cylinders.

### BRIEF DESCRIPTION OF THE DRAWINGS

Additional embodiments and further developments of the invention are included in the figures. The following figures show an embodiment of a combustion engine which has a generator. However, the details and characteristics included in the individual figures are not restricted to the respective figure or embodiment. Instead it is possible to combine one or several characteristics with one or several characteristics from different figures, as well as with characteristics included in the above description in order to form new embodiments. In particular, the subsequent descriptions do not have the purpose of restricting the respective scope of protection but explain individual characteristics and their potential interaction. It is shown:

FIG. 1 a schematic view of an engine having a crankshaft and a generator having a generator shaft;

FIG. 2 a torque curve of a generator and a combustion engine applied via the crank angle position of the crankshaft of the combustion engine;

FIG. 3 a speed curve of the generator shaft applied via the crankshaft position of the crankshaft of the combustion engine;

FIG. 4 a torque curve depicted as the position of the crankshaft in crank angle degrees, in the horizontal axis, and crankshaft torque, in the horizontal axis;

FIG. 5A a schematic view of the crankshaft gear connected with the crankshaft;

FIG. 5B a schematic of two potential orthogonal vector decompositions of the front gear edge normal; and

FIG. 5C a schematic of two potential orthogonal vector decompositions of the rear tooth flank.

### DETAILED DESCRIPTION OF THE PREFERRED EMBODIMENTS

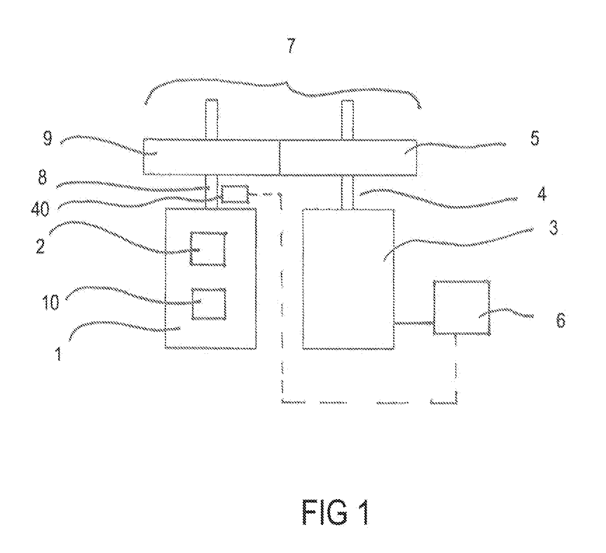

FIG. 1 shows a combustion engine 1 with a first cylinder 2 and a second cylinder 10. FIG. 1 also shows a generator 3 with a generator shaft 4, which has a generator shaft gear 5 and a control unit 6, which control at least the generator 3, and a rotational connection 7. Via the generator shaft gear 5, the crankshaft 8 is connected with the generator shaft 4 by a crankshaft gear 9. The control unit 6 controls the generator 3 in such a way that during the operation of the combustion engine 1 the crankshaft gear 9 is permanently engaged with the generator shaft gear 5. Preferably, the permanent contact between the crankshaft gear 9 and the generator shaft gear 5 is achieved in that the control device 6 controls the generator in such a way that during the compression stroke a conversion torque is generated within the generator when the combustion engine is operating. Said conversion torque has a decelerating effect on the generator shaft 4 and, via the generator shaft gear 5 and the crankshaft gear 9, on the crankshaft 8. Preferably, even during the induction stroke, the expansion stroke and the exhaust stroke, the control device 6 controls the generator 3 in such a way that the generator shaft is decelerated by the conversion torque. It is preferred when the combustion engine 1 comprises a crankshaft position sensor 40 by which the control device 6 can determine the crankshaft position. The crankshaft position sensor is connected with the control device 6.

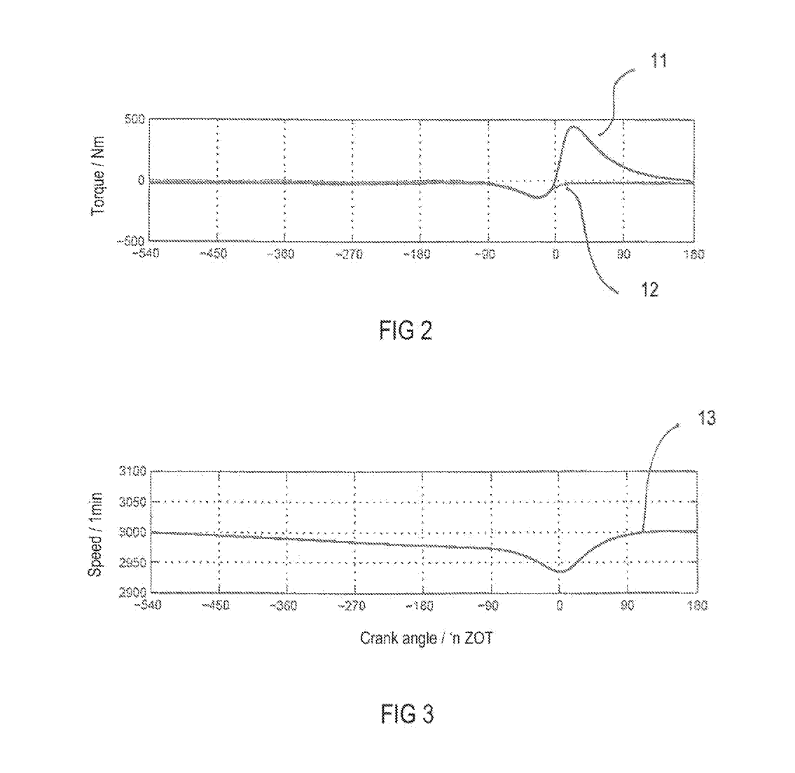

FIG. 2 shows a crankshaft torque curve 11 of a one-cylinder combustion engine, which is caused by the internal cylinder pressure. The crank angle range of the negative crankshaft torque curve between a crank angle of between −90° and 0° is generated during the compression stroke by means of the compression pressure which is transmitted via the piston and the connecting rod to the crankshaft of the combustion engine. Energy is also needed for the load change within the combustion engine, which results in a negative crankshaft torque. When using several cylinders, the respective crankshaft torque curves add up and the effect a fluctuating crankshaft torque has on the crankshaft of the combustion engine can be reduced. However, using the combustion engine with a generator, for example as range extender in a motor vehicle, usually allows for the use of fewer cylinders, in particular only two cylinders. Using two cylinders would result in a crankshaft torque curve at the crankshaft which is produced by the sum between a crankshaft torque curve 11, as shown in FIG. 2, and a further crankshaft torque curve which is offset to the left by a 360° crank angle along the X axis in FIG. 2. The generator shaft torque curve 12 shown in FIG. 2 corresponds to an embodiment in which the combustion engine is designed with a single cylinder. Accordingly, the amount of the generator shaft torque curve 12 has a maximum which ranges between −90° and 0° crank angle of the crankshaft. Said range corresponds to the range in which the compression stroke of the cylinder of the combustion engine occurs.

FIG. 3 shows a speed curve 13 of the crankshaft which corresponds to the generator shaft torque curve 12. Corresponding to the maximum amount of the generator shaft torque curve 12 the incline of the speed curve 13 has a minimum. Preferably, the minimum of the speed curve 13 is reached when the crankshaft torque curve 11 in the compression phase reaches a value of zero. For transmitting a torque form the crankshaft to the generator shaft or from the generator shaft to the crankshaft gear wheels, which have a split gear, have been provided in a special embodiment.

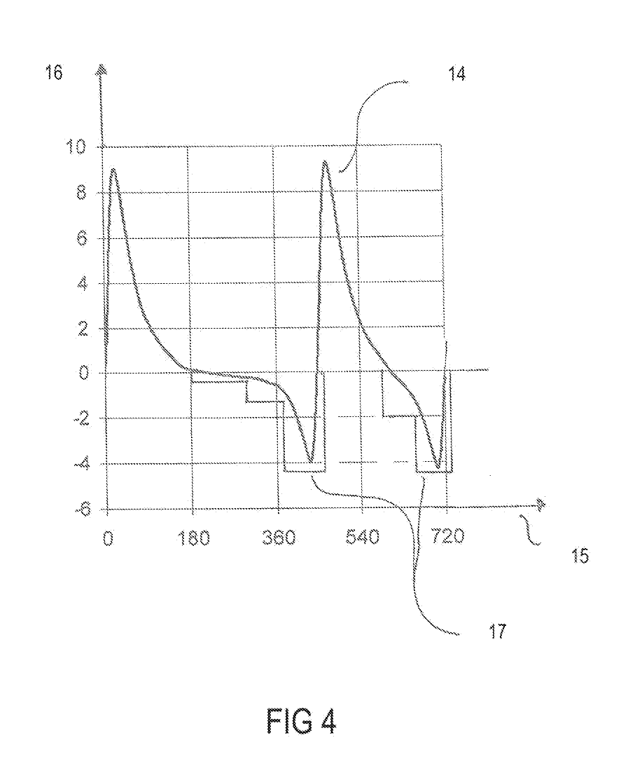

FIG. 4 shows a torque curve 14 at a crankshaft caused by the internal cylinder pressure, as it would occur in a V2 combustion engine having two cylinders with a cylinder bank angle of 90°. On the vertical axis 16, the crankshaft torque is shown at the crankshaft. The horizontal axis 15 depicts the position of the crankshaft in crank angle degrees. The positions of the crankshaft on which the respective maximum cylinder pressures occur are offset to one another by approximately 440 crank angle degrees. The generator torque curve at the generator shaft which is caused by the generator is depicted by the generator shaft torque curve 17. The integral of the crankshaft torque curve 14 over the horizontal axis 15 corresponds to the amount of the integral of the generator shaft torque curve 17 over the axis 15. In this embodiment, the generator shaft torque curve 17 can be displayed by a square function. Preferably, said square function is implemented by means of pulse-width modulated signals of the generator control.

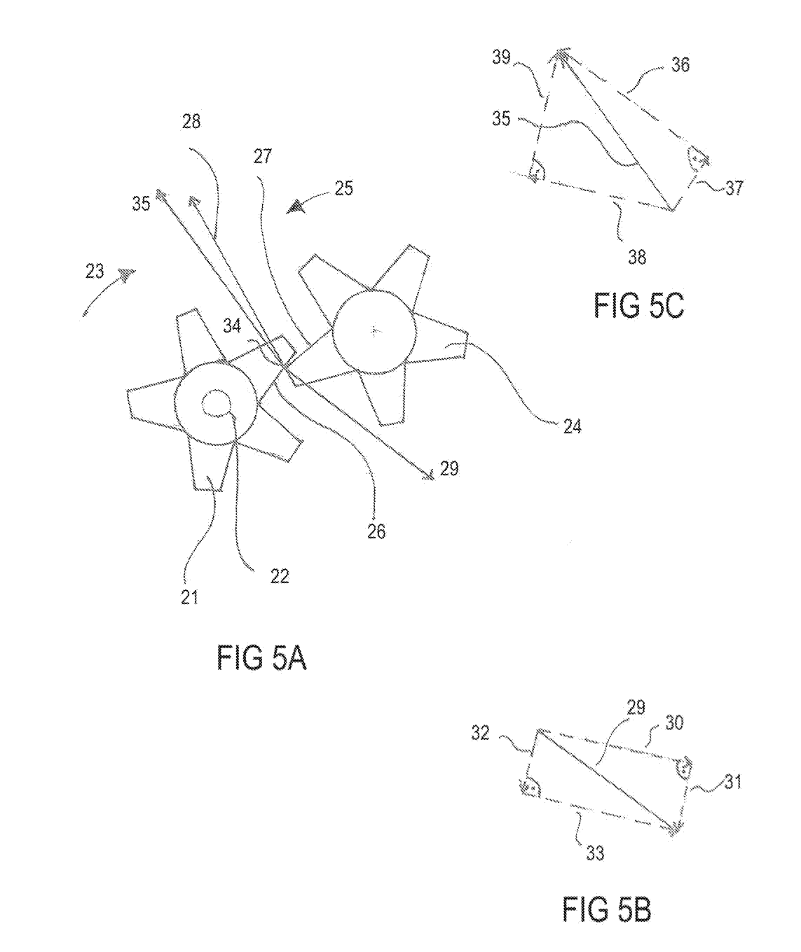

FIG. 5 shows a crankshaft gear 21 which is firmly connected with the crankshaft 22. The only rotational direction of the crankshaft is the rotational direction 23. FIG. 5 shows also a generator shaft gear 24 which rotates in the direction of the arrow 25. In the arrangement shown in FIG. 5 the gear force 28 which acts from the generator shaft gear on the crankshaft gear decelerates the crankshaft gear. At the point of load application 34, the gear force 28 acts from the generator shaft gear on the crankshaft gear.

The crankshaft gear comprises front gear tooth flanks, for example, the front gear tooth flank 26. At the point of load application 34, the front gear tooth flank 26 comprises a front gear edge normal 29. Two potential orthogonal vector decompositions of the front gear edge normal 29 are shown on the bottom right of FIG. 5. A first potential orthogonal vector decomposition divides the front gear edge normal 29 in vectors 32 and 31. A second potential orthogonal vector decomposition divides the front gear edge normal 29 in vectors 32 and 33. In particular, each of the vectors 30, 31, 32 and 33 which also runs through the point of load application 34 produces a torque in rotational direction 23 of the crankshaft gear 21.

Accordingly, the generator shaft gear comprises rear gear tooth flanks, for example, the rear gear tooth flank 27. At the point of load application 34, the rear gear tooth flank 27 comprises a rear gear edge normal 35. Two potential orthogonal vector decompositions of the rear gear edge normal 35 are shown on the top right of FIG. 5. A first potential orthogonal vector decomposition divides the rear gear edge normal 35 in vectors 36 and 37. A second potential orthogonal vector decomposition divides the rear gear edge normal 35 in vectors 38 and 39. In particular, each of the vectors 36, 37, 38 and 39 which also runs through the point of load application 34 produces a torque in the opposite direction 25 of the generator shaft gear 24.

According to the invention, at least between a first moment prior to the start of combustion in a cylinder and a second moment following the start of combustion in the cylinder, a direct contact between the crankshaft gear and the generator shaft gear is implemented via one or several front gear tooth flanks of the crankshaft gear and one or several rear gear tooth flanks of the generator shaft gear.

1. A combustion engine comprising:
at least a cylinder,
a generator having a generator shaft with a generator shaft gear,
a control unit which controls at least the generator, and
a rotational connection which connects a crankshaft having a crankshaft gear of the combustion engine with the generator shaft,
wherein the generator shaft rotates in the opposite direction of the crankshaft and the generator shaft is arranged in parallel to the crankshaft,
wherein products of moments of inertia and the respectively associated speed ratios of individual rotary components rotationally coupled by the rotational connection cancel each other out at least approximately and the control unit controls the generator in such a way that at least between a first moment prior to the start of combustion in a cylinder and a second moment following the start of combustion in the cylinder a gear force of the generator shaft gear acts on the crankshaft gear, thus decelerating the crankshaft gear.

2. The combustion engine according to claim 1, wherein during an entire operation cycle of the respective cylinder a gear force originating from the generator shaft gear acts on crankshaft gear which decelerates the crankshaft gear.

3. The combustion engine according to claim 1 wherein, a course of an amount of the gear force during a compression phase in a respective cylinder has a local maximum.

4. The combustion engine according to claim 1, wherein the combustion engine includes at least one of a crankshaft position sensor or a model in the control unit, the at least one of the crankshaft position sensor or the model is implemented to detect a crankshaft position and the gear force is regulated depending on a crankshaft position of the crankshaft.

5. A method for operating a generator, the generator is coupled by a rotational connection with a combustion engine having at least a cylinder, the combustion engine includes a generator shaft wherein the generator shaft is rotating in opposite direction to a crankshaft of the combustion engine and the generator shaft is arranged in parallel fashion to the crankshaft and products of moments of inertia and the respectively associated speed ratios of individual rotary components rotationally coupled by the rotational connection cancel each other out at least approximately, in which the generator is controlled by a control unit in such a way that between a moment prior to the start of combustion in a cylinder and a moment following the start of combustion in a cylinder a gear force originating from the generator shaft gear acts on the crankshaft gear, which decelerates the crankshaft gear.

6. A method according to claim 5, wherein over the entire combustion cycle of the respective cylinder a decelerating gear force originating from the generator shaft gear is acting on the crankshaft gear.

7. A method according to claim 5 a course of the gear force is controlled by the control unit in such a way that the course of the gear force in a compression phase of each cylinder of the combustion engine amounts to a local maximum.

8. A method according to claim 6, wherein a speed fluctuation of the crankshaft of the combustion engine is at least partially increased by controlling the gear force during a combustion cycle of the combustion engine.

9. A method of using a combustion engine according to claim 1, as range extender in a motor vehicle.
